(19) United States
(12) Patent Application Publication
(10) Pub. No.: US 2009/0161374 A1
(43) Pub. Date: Jun. 25, 2009

(54) Biaxial folding lamp structure

(75) Inventors: Kuo-Hsin Teng, Taipei (TW); Hon-Lun Chen, Taipei (TW); Wen-He Lin, Taipei (TW)

Correspondence Address: REED SMITH LLP, Suite 1400, 3110 Fairview Park Drive, Falls Church, VA, 22042, US

(73) Assignee: PRODISC TECHNOLOGY INC.

(21) Appl. No.: 12/010,359

(22) Filed: Jan. 24, 2008

(30) Foreign Application Priority Data
Dec. 19, 2007 (TW) 096221638

(51) Int. Cl. F21S 8/00

(52) U.S. Cl. 362/427

(57) ABSTRACT

A biaxial folding lamp structure comprises a support unit, a first lighting unit and a second lighting unit, wherein the support unit has a first surface and a second surface; the first lighting unit is combined with the first surface via a first pivot; and the second lighting unit is combined with the second surface via a second pivot. With the first and second lighting units, the biaxial folding lamp structure can simultaneously provide lighting in two axial directions, thereby increasing an illuminated area. In addition, the first and second pivots allow the first and second lighting units to be folded up for storage.

### BACKGROUND OF THE INVENTION

1. Technical Field

The present invention relates to a biaxial folding lamp structure, and more particularly, to a biaxial folding lamp structure which can provide lighting in two axial directions simultaneously and be folded up.

2. Description of Related Art

Among all the indoor and outdoor recreational activities, bridge and mahjong are the favorites of many people. Bridge and mahjong are usually played indoors, with players each sitting at a side of a rectangular table. Generally, an indoor ceiling lamp is directly used as a lighting apparatus for a game of bridge or mahjong but the ceiling lamp is too far away from the table surface to provide sufficient illumination. Therefore, some people use a cantilever floor lamp as a light source, which can be drawn as close to the table surface as possible to increase lighting effect.

FIG. 1 is a schematic view showing an application of a conventional cantilever floor lamp 10. As shown in FIG. 1, the cantilever floor lamp 10 comprises a fork-like base 11, a cantilever 12 and a lamp shade 13. The fork-like base 11 is combined with the cantilever 12 and placed against a leg of a table 20 in a clamping manner for securing the conventional cantilever floor lamp 10 in position. In addition, the cantilever 12 is combined with the lamp shade 13 at another end thereof, wherein the lamp shade 13 is combined with a light source.

When the conventional cantilever floor lamp 10 is used beside the mahjong table 20, the light source of the conventional cantilever floor lamp 10 is adjusted to a central location above the mahjong table 20. Meanwhile, mahjong tiles 30 are lined up at edges of the table. Therefore, when the light source casts light from the central location above the table onto the table surface, a shadow is formed on a backside of the mahjong tiles 30. As a result, the players tend to have problems in accurately identifying patterns on the mahjong tiles 30 after a long game. This is also harmful to the players' eyesight.

Furthermore, the light source used in the conventional cantilever lamp 10 is, in most cases, a tungsten lamp or a compact fluorescent lamp (CFL). A tungsten lamp has a short service life and generates light with a high temperature. When a tungsten lamp is used in summer time, a user not only has to bear the sweltering heat of the season, but also has to endure heat generated by the tungsten lamp. However, if a compact fluorescent lamp is used instead, the light provided by the compact fluorescent lamp may not be sufficient. Moreover, the light source used in the conventional cantilever floor lamp 10 usually emits ultra-violet rays, which may be injurious to human bodies with prolonged use of the lamp.

### SUMMARY OF THE INVENTION

The present invention provides a biaxial folding lamp structure, wherein a first lighting unit and a second lighting unit are combined with a first surface and a second surface of a support unit respectively, so as to provide lighting in two axial directions simultaneously, thereby increasing an illuminated area. In addition, the installation of a first pivot and a second pivot allows the first and second lighting units to be folded up for storage.

To achieve this end, the biaxial folding lamp structure comprises a support unit, which is a column having a first surface and a second surface; a first lighting unit combined with the first surface via a first pivot; and a second lighting unit combined with the second surface via a second pivot.

In the above-mentioned biaxial folding lamp structure, the support unit can be an elongate column or a U-shaped column; the first surface can have a pair of first side panels formed on two sides thereof; and the second surface can have a pair of second side panels formed on two sides thereof. The support unit can be further combined with a C-shaped clamp on a first end thereof.

In the above-mentioned biaxial folding lamp structure, the first lighting unit can be a light-emitting diode lighting unit while the second lighting unit can also be a light-emitting diode lighting unit. The first pivot can be a damper pivot while the second pivot can also be a damper pivot.

Implementation of the present invention at least provides the following advantageous effects:

1. Lighting in two axial directions is simultaneously provided to increase an illuminated area.

2. The first and second lighting units can be folded up for easy storage.

3. The use of a light-emitting diode lighting unit increases a service life of the lighting unit and reduces ultra-violet rays which may otherwise be generated.

The features and advantages of the present invention are disclosed in detail in the following description so that a person skilled in the art can understand the technical content of the present invention and put it into practice. A person skilled in the art can readily comprehend the objectives and advantages of the present invention by referring to the content disclosed herein, the appended Claims and the accompanying drawings.

### BRIEF DESCRIPTION OF THE DRAWINGS

FIG. 1 is a schematic drawing showing an application of a conventional cantilever floor lamp.

FIG. 2A is a perspective view of a first embodiment of a biaxial folding lamp structure according to the present invention.

FIG. 2B illustrates a folded state of the biaxial folding lamp structure according to the present invention.

FIG. 3 is a perspective view of a second embodiment of the biaxial folding lamp structure according to the present invention.

FIG. 4A is a perspective view of a third embodiment of the biaxial folding lamp structure according to the present invention.

FIG. 4B is a cross-sectional view along a line A-A in FIG. 4A showing an embodiment of a support unit according to the present invention.

FIG. 5A is a perspective view of a fourth embodiment of the biaxial folding lamp structure according to the present invention.

FIG. 5B is a cross-sectional view along a line B-B in FIG. 5A showing another embodiment of the support unit according to the present invention.

FIG. 6 illustrates an application of the biaxial folding lamp structure according to the present invention.

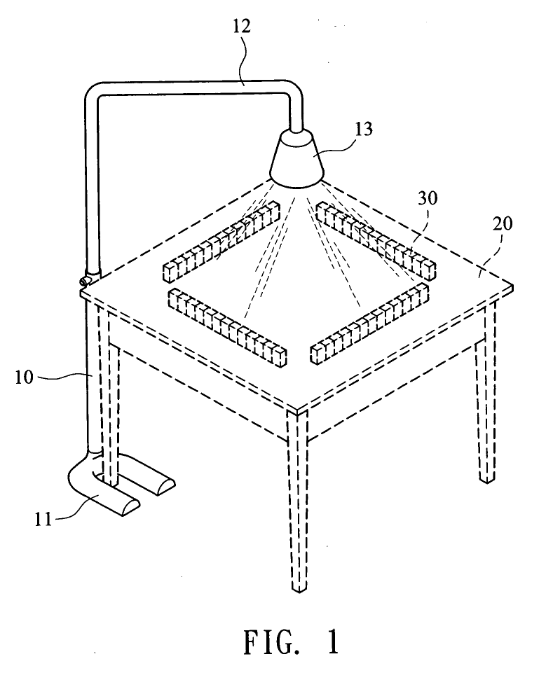

### DETAILED DESCRIPTION OF THE PREFERRED EMBODIMENT

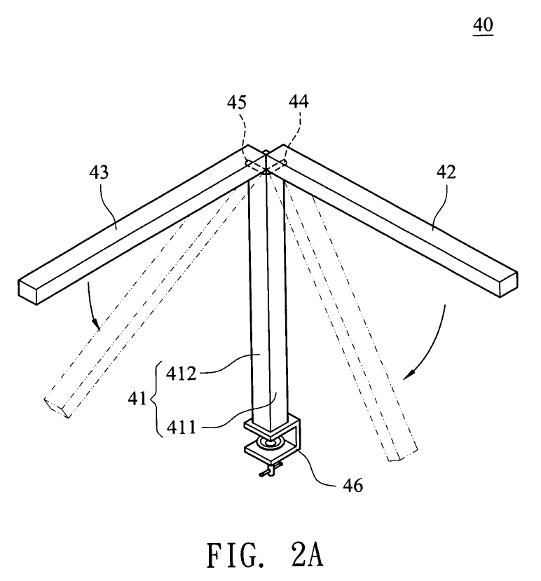

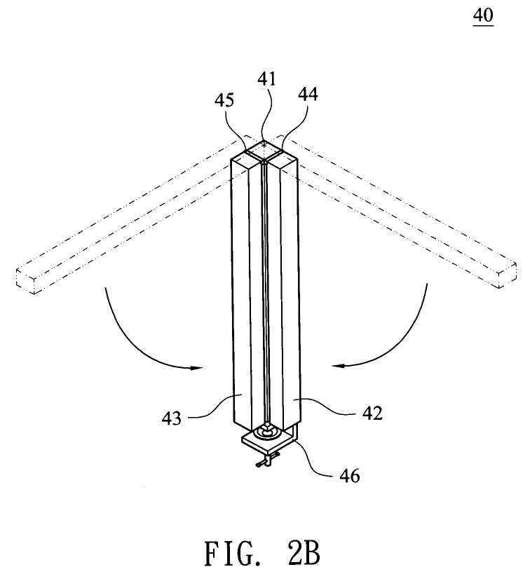

As shown in FIG. 2A, the first embodiment of the present invention is a biaxial folding lamp structure 40 comprising a support unit 41, a first lighting unit 42 and a second lighting unit 43.

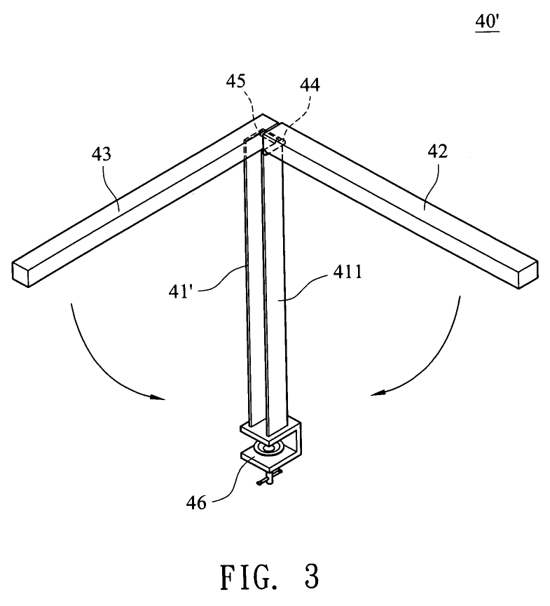

As shown in FIGS. 2A and 3, the support unit 41, 41′ can be an elongate column (FIG. 2A) or a U-shaped column (FIG. 3). The support unit 41, 41′ can be a hollow column wherein control lines of the first lighting unit 42 and of the second lighting unit 43 can be hidden. As shown in FIG. 2A, the support unit 41 has a first surface 411 and a second surface 412 for combining with the first lighting unit 42 and the second lighting unit 43 respectively, so as to provide lighting in two axial directions and thereby increase an illuminated area.

As shown in FIG. 2A, the support unit 41 can be an elongate column. The first lighting unit 42 can be combined with the first surface 411 of the support unit 41 via a first pivot 44 while the second lighting unit 43 can be combined with the second surface 412 of the support unit 41 via a second pivot 45, wherein the first pivot 44 and the second pivot 45 can be damper pivots. The first lighting unit 42 can rotate around a rotation axis defined by the first pivot 44 so as to be folded up, as shown in FIG. 2B. Similarly, the second lighting unit 43 can also rotate around a rotation axis defined by the second pivot 45 and be folded up for easy storage.

The first lighting unit 42 and the second lighting unit 43 can both be a light-emitting diode lighting unit, wherein the light-emitting diode lighting unit can be a white light-emitting diode; or a combination of a red light-emitting diode, a green light-emitting diode and a blue light-emitting diode; or other suitable light-emitting diodes. A user can adjust a color temperature generated by the light-emitting diode lighting unit by, for example, adjusting a light intensity of the red light-emitting diode, the green light-emitting diode and the blue light-emitting diode, so as to obtain a most comfortable color temperature for the user.

Using a light-emitting diode lighting unit as the first lighting unit 42 and the second lighting unit 43 not only serves the purpose of energy saving, but also prevents ultra-violet rays from being generated and harming human bodies. Furthermore, a light-emitting diode lighting unit is a cold light source, so that light rays emitted therefrom do not have a high temperature. Therefore, when a light-emitting diode lighting unit is used in summer, the user will not feel uncomfortably hot.

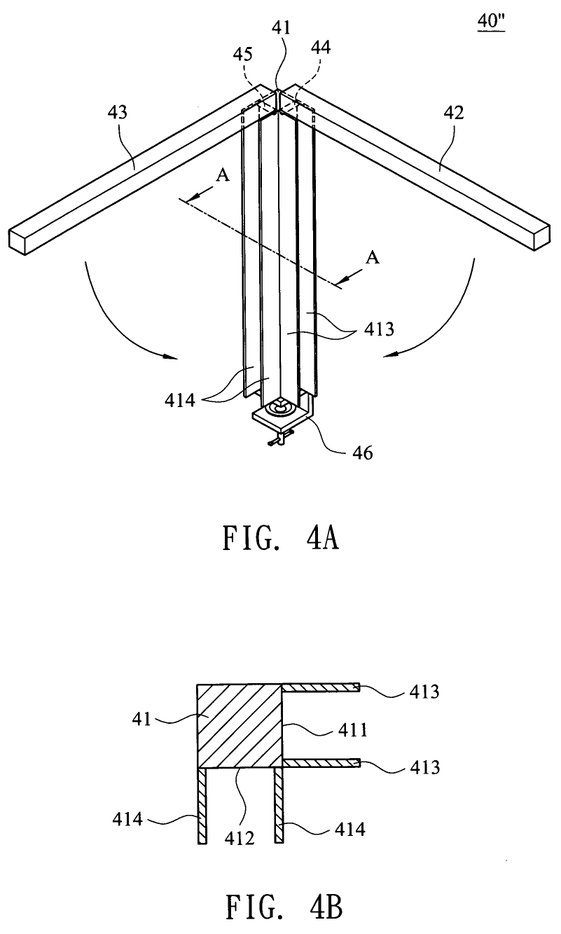

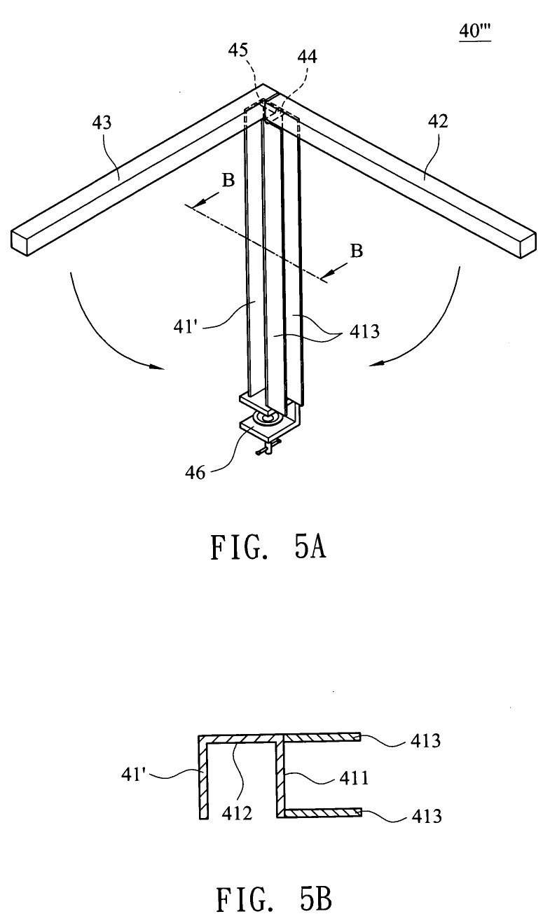

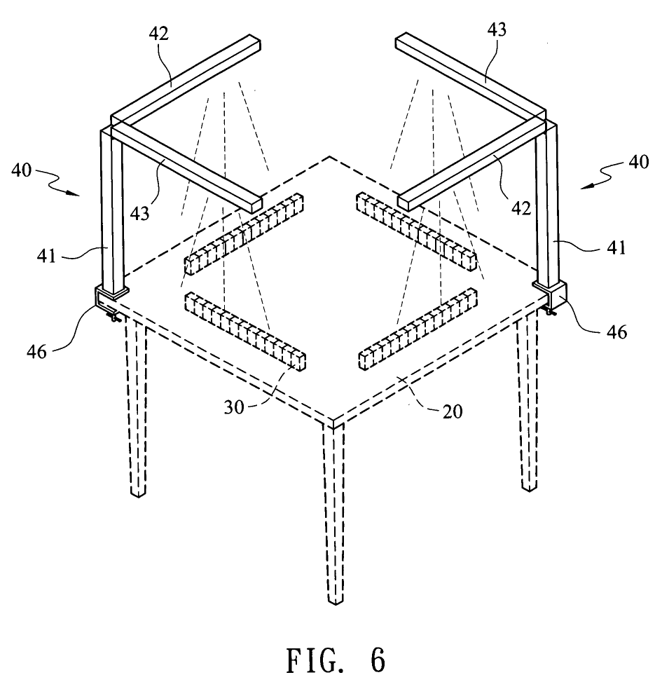

As shown in FIG. 4B, the first surface 411 of the support unit 41 can have a pair of first side panels 413 formed on two sides thereof while the second surface 412 can also have a pair of second side panels 414 formed on two sides thereof. Alternately, only one of the first surface 411 and the second surface 412 has the first side panels 413 or the second side panels 414 formed on two sides thereof. In addition, as shown in FIG. 5B, the first surface 411 of the support unit 41′ can also have the first side panels 413 formed on two sides thereof.

As shown in FIG. 4A, by rotating the first lighting unit 42 around the rotation axis defined by the first pivot 44, the first lighting unit 42 can be received in a space formed by the first surface 411 and the first side panels 413, wherein the first side panels 413 can protect the first lighting unit 42 from being damaged by collision. Similarly, the second lighting unit 43 can also be received in a space formed by the second surface 412 and the second side panels 414, wherein the second side panels 414 can protect the second lighting unit 43 from being damaged by collision.

As shown in FIG. 5B, the support unit 41′ can be a U-shaped column. As shown in FIG. 5A, the first lighting unit 42 can be combined with the first surface 411 of the support unit 41′ via the first pivot 44 while the second lighting unit 43 can be combined with the second surface 412 of the support unit 41′ via the second pivot 45. Furthermore, the second lighting unit 43 can be rotated so as to be received in a space formed by the U-shaped column. Moreover, the first surface 411 can have a pair of first side panels 413 formed on two sides thereof. When the first lighting unit 42 is rotated and therefore received in a space formed by the first surfaces 411 and the first side panels 413, the first side panels 413 can protect the first lighting unit 42.

The support unit 41 of the biaxial folding lamp structure 40 in this embodiment can be placed directly on a floor (not shown) or combined with a base or a fork-like base (not shown) so that the lamp structure 40 is more securely placed on the floor. As shown in FIG. 6, in order to provide more convenient use, a first end of the support unit 41, namely a lower end of the support unit 41, can be further combined with a C-shaped clamp 46, so that the biaxial folding lamp structure 40 can be directly secured at a table corner.

As shown in FIG. 6, when two opposite corners of a rectangular table are each installed with the biaxial folding lamp structure 40 in this embodiment, each of four sides of the rectangular table is provided with proper lighting. The first lighting unit 42 and the second lighting unit 43 can be folded up after use for easy storage.

It should be noted that the above-mentioned embodiments are described to explain the features of the present invention so that a person skilled in the art can understand the content of the present invention and put it into practice, and these embodiments are not intended to limit the scope of the present invention. Therefore, all equivalent modifications or alterations which do not depart from the spirit of the present invention are encompassed by the appended Claims.

1. A biaxial folding lamp structure, comprising:
a support unit, which is a column having a first surface and a second surface;
a first lighting unit, pivotally connected to the first surface via a first pivot; and
a second lighting unit, pivotally connected to the second surface via a second pivot,
wherein the first lighting unit and the second lighting unit are configured to fold up relative to the support unit via the first pivot and the second pivot, respectively.

2. The lamp structure as claimed in claim 1, wherein the support unit is an elongate column.

3. The lamp structure as claimed in claim 1, wherein a cross-section of the support unit is U-shaped.

4. The lamp structure as claimed in claim 1, wherein the first surface has a pair of first side panels formed on two sides thereof.

5. The lamp structure as claimed in claim 1, wherein the second surface has a pair of second side panels formed on two sides thereof.

6. The lamp structure as claimed in claim 1, wherein the support unit is further combined with a C-shaped clamp at a first end thereof.

7. The lamp structure as claimed in claim 1, wherein the first lighting unit is a light-emitting diode lighting unit.

8. The lamp structure as claimed in claim 1, wherein the second lighting unit is a light-emitting diode lighting unit.

9. The lamp structure as claimed in claim 1, wherein the first pivot is a damper pivot.

10. The lamp structure as claimed in claim 1, wherein the second pivot is a damper pivot.
